(19) United States
(12) Patent Application Publication
(10) Pub. No.: US 2012/0091074 A1
(43) Pub. Date: Apr. 19, 2012

(54) SECURE TOOL HANGER STRUCTURE

(76) Inventor: CHI-TSAI CHANG, Taichung City (TW)

(21) Appl. No.: 12/906,152

(22) Filed: Oct. 18, 2010

(51) Int. Cl. A47F 7/00; E05B 73/00

(52) U.S. Cl. 211/4

(57) ABSTRACT

A secure tool hanger structure is particularly provided for hanging a spanner like elongate tool for exhibition of the tool in a secured manner. The tool hanger structure includes a hanger body having a lower portion forming a projecting insertion slot for receiving and positioning the insertion of a spanner tool. A retention board is formed on one side or two sides of the body. The board forms a bending flange in the form of a thinned fold line at an intermediate section thereof. The retention board has an end forming a projecting insertion fastener, which is insertable into an end of a bar projecting from a central portion of the body for the purposes of inserting and positioning of the spanner to form an enclosed anti-theft structure for the spanner tool and thus ensure secure, anti-theft hanging and use of the tool for hanging exhibition.

### (a) TECHNICAL FIELD OF THE INVENTION

The present invention generally relates to a secured tool hanger structure, which comprises a hanger body, which, functioning for insertion and retention of a spanner like tool, has a lower portion forming a tool insertion slot and comprises a retention board extending from a side wall of the slot or a side of the body for looping and fixing purposes, the retention board having an extension end forming an insertion fastener for being directly fit into a central through hole defined in a bar that is for positioning purposes for tool insertion after the retention board is set to loop and fix a head portion of the inserted tool, so as to securely enclose and fix the tool, realizing a secure and anti-theft effect for a tool hung for exhibition.

### (b) DESCRIPTION OF THE PRIOR ART

A small hand tool is often packaged in a hanging manner for easy inspection by a consumer for the sales of the tool. For a regularly used spanner, including box-end spanners or adjustable spanners, or even ratchet spanners that have an expandable jawed end, since the spanner has an elongate handle or grip and an expanded head portion, in packaging of the tool, due to the elongate volume and/or the need for hanging exhibition, to consider convenience and security of hanging exhibition, a thick paper board is adopted to form a hanger, which is combined with an enclosure covering the tool to allow a consumer to easily inspect the tool through the transparent material of the enclosure. The integrated packaging helps preventing the tool from stealing or falling. However, for a general tool user, since such a package prevents direct contact and handling of the tool by a user for inspection purposes, it often becomes a barrier for purchase of the tool. Further, the package formed with paper board often forms a fold line to define a removal opening formed in the back side opposite to where the tool is set. When the tool is hung for exhibition, such an opening provides an easy way of theft for the fold line can be easily broken by squeezing the tool backward of the paper board. This makes the hanging exhibition of tool very risky. Thus, it is desired to have an improvement over the existing tool hanging package in order to ensure security of hanging exhibition and sales of spanner tools.

### SUMMARY OF THE INVENTION

In view of the problem that the existing hanger structure cannot meet the need of packaging and hanging an elongate spanner like tool, the present invention aims to provide a secure tool hanger structure, wherein a hanger body has a lower portion forming an insertion slot for receiving a tool to be directly fit therein and positioned and comprises a retention board that has an insertion fastener for directly enclosing and covering a head portion of the tool so as to realize secure packaging that allows hanging and positioning of the tool without undesired separation, whereby the packaging of tool is made to realize use of secure hanging and effectively improving the insufficient theft resistance capability of the existing ways of hanging spanner tools.

An objective of the present invention is thus to provide a hanger body having a lower portion forming an insertion slot for receiving the insertion of a spanner tool and forming a retention board on one side or two sides of the body for looping and fixing purposes. The retention board has an end forming an insertion fastener, which, after the tool is looped, is insertable into a bar mounted to a central portion of the body for fixing purposes, whereby the tool can be inserted and retained in a secured manner so as to realize a hanger for secure hanging and packaging of tool for exhibition.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a hanger body according to the present invention.

FIG. 2 is a perspective view showing a tool hung by the hanger body according to the present invention.

FIG. 3 is a perspective view illustrating removal of the tool from the hanger body of the present invention.

FIG. 4 is a perspective view showing a hanger according to another embodiment of the present invention.

FIG. 5 is a perspective view demonstrating the use of the hanger shown in FIG. 4.

FIG. 6 is an exploded view showing a hanger body and a suspension plate according to the present invention.

FIG. 7 is a perspective view showing the use of the device of FIG. 6.

FIG. 8 is a perspective view showing packing and storage of the device of FIG. 6.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

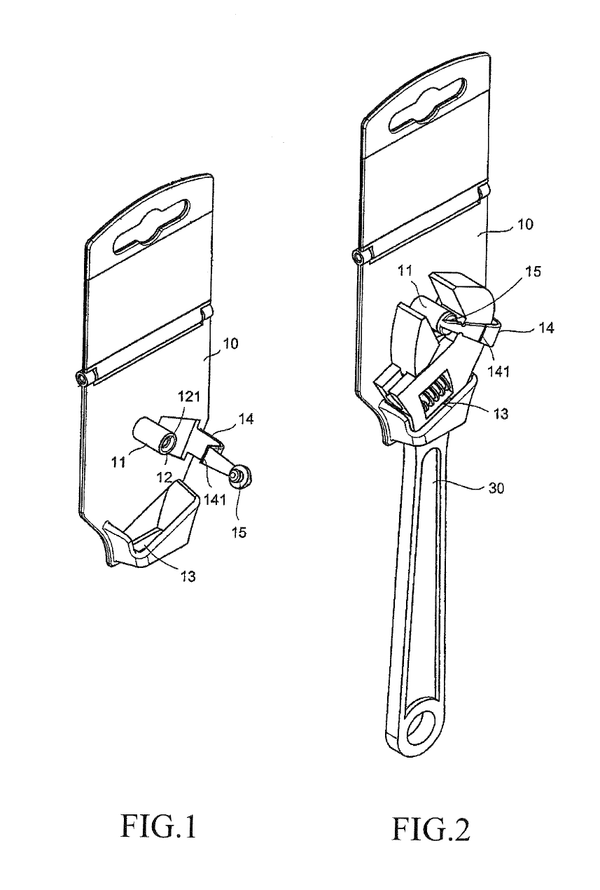

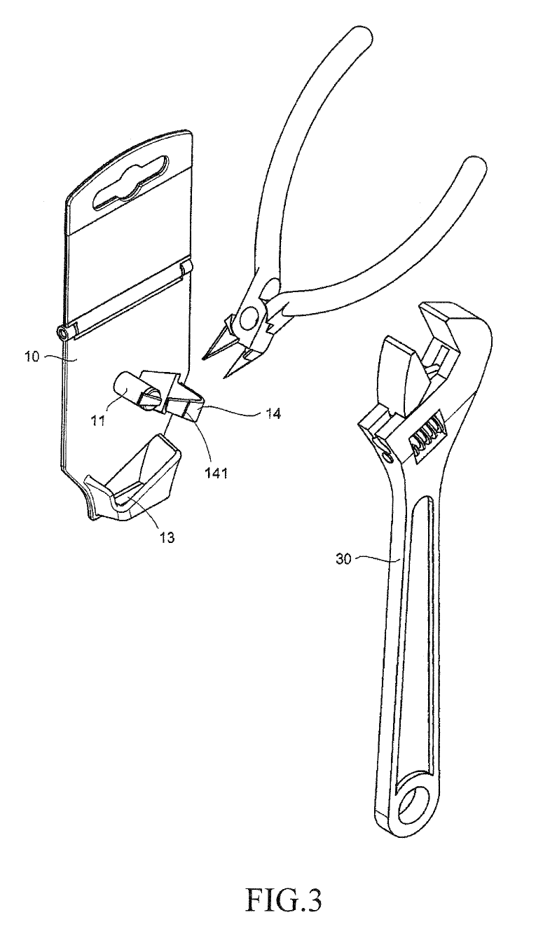

As shown in FIGS. 1 to 3, the present invention provides a secure tool hanger structure, which comprises a hanger body, serving as a main portion of hanging a tool, generally designated at 10. The hanger body 10 is made in the form of an elongate board, which has a surface forming a bar 11 projecting outward from a site below a center of the surface for tool positioning and retaining purposes. The bar is made in a tubular form having a hole 12 extending through a center thereof. The board body 10 has a lower portion on which a frame is formed to project outward from the surface of the board body to form an enclosing configuration that defines an insertion slot 13 for receiving insertion of a spanner tool 30 that is of an elongate and slender configuration therein. On the surface of the body 10 or on one side wall of the enclosing frame of the insertion slot 13, a retention board 14, which is in the form of an elongate plate, is integrally formed and extends outward therefrom. The retention board 14 has an extension end that forms an insertion fastener 15 projecting therefrom in a direction of insertion. The insertion fastener 15 projects for a predetermined length and has a distal end forming a barb like end rim. The projection length of the insertion fastener 15 preferably exceeds half of the total depth of the central through hole 12 of the bar 11. The through hole 12 provided for insertion purposes can be made in the form of a stepped bore or having a circumferential engagement groove 121 formed by recessing an inside wall of the hole at a predetermined depth, whereby easy insertion and fixing of the end rim of the distal insertion end of the insertion fastener 15 can be made. To facilitate insertion and retention of the spanner tool 30, the retention board 14 extending from the body 10 or the frame of the insertion slot 13 can be alternatively made as a flexible board in the form of a looping band, or further alternatively the retention board 14 is made as a board having an L-shaped enclosing configuration. To facilitate insertion of the tool 30, the retention board 14 is preferably provided at approximately an intermediate section thereof with a thinned fold line 141 that is for bending or flexing purposes and extends across a surface of the board, whereby the portion of the board associated with the extension end where the insertion fastener 15 is formed is bendable outward to form a wide opening for insertion through which the tool 30 can be easily inserted and positioned. With the tool 30 being positioned against an outer circumference of the bar 11, the insertion fastener 15 of the retention board 14 is fit into the central through hole 12 of the bar 11 to form inserted engagement for clamping and fixing so that a head portion of the tool 30 that is inserted is looped and covered and secure anti-theft hanging of the tool is realized. In this way, when the tool is hung for exhibition purposes, an unauthorized person cannot remove the insertion fastener 15 from the engagement fixing position for purpose of releasing. Thus, secure and enclosed hanging of the tool 30 for exhibition purposes can be realized.

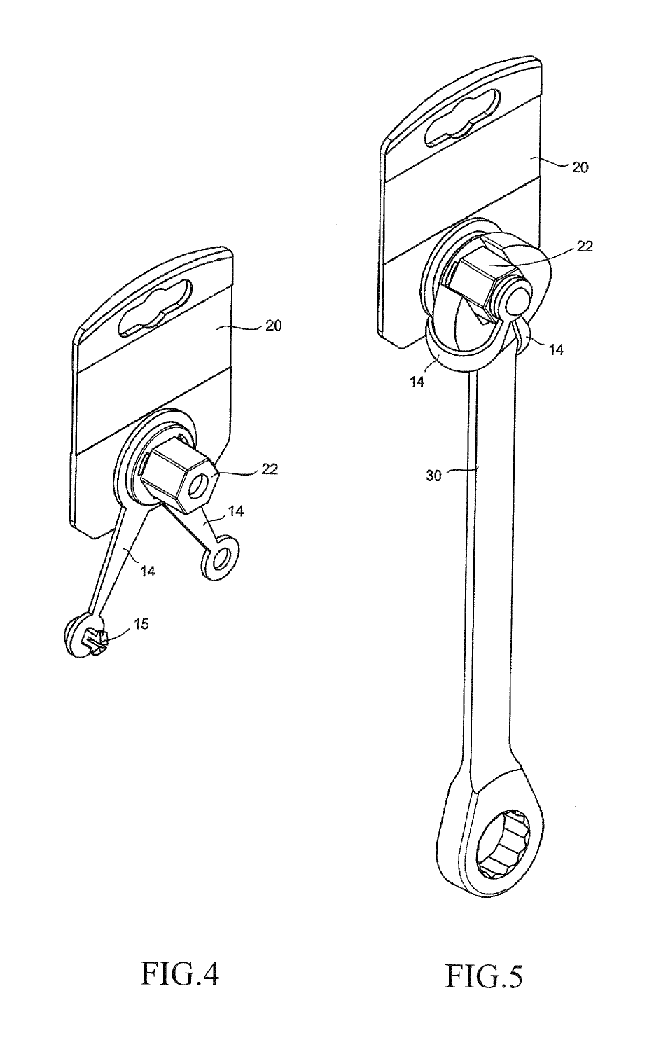

For an arrangement of hanging and insertion of a spanner tool 30 having a small working head, such as a box-end spanner, in order to improve security of insertion, a design shown in FIGS. 4 and 5 may be adopted, wherein the retention board 14 for looping purposes can be made in the form of enclosing bands respectively located on opposite sides of the frame of the insertion slot 13 or the body 10 and extended so as to directly and completely enclose opposite sides of the head portion of the tool 30. With one of the bands of the retention board 14 forming an insertion fastener 15 that is insertable into the other band to have the bands of the retention board 14 partly overlapping each other for enclosing purposes, the purposes of hanging and insertion of tool in a secure and enclosed arrangement can be realized for both large and small tools 30.

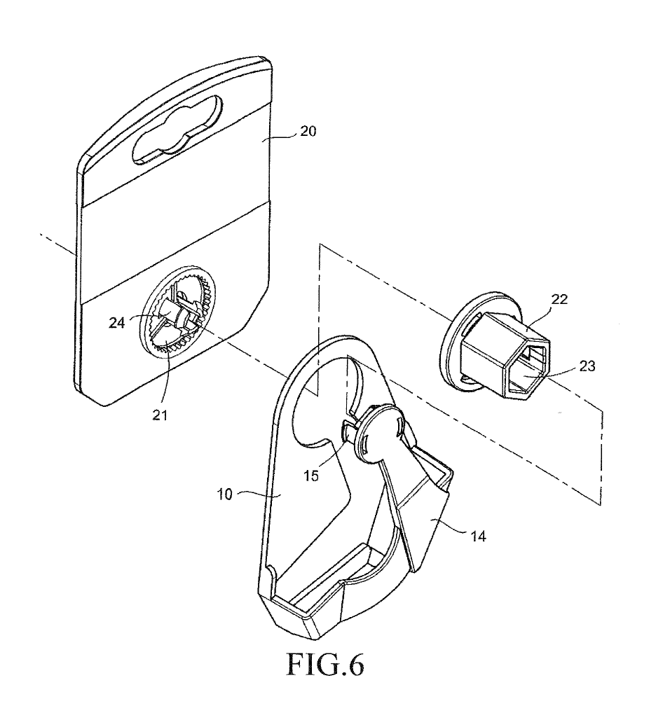

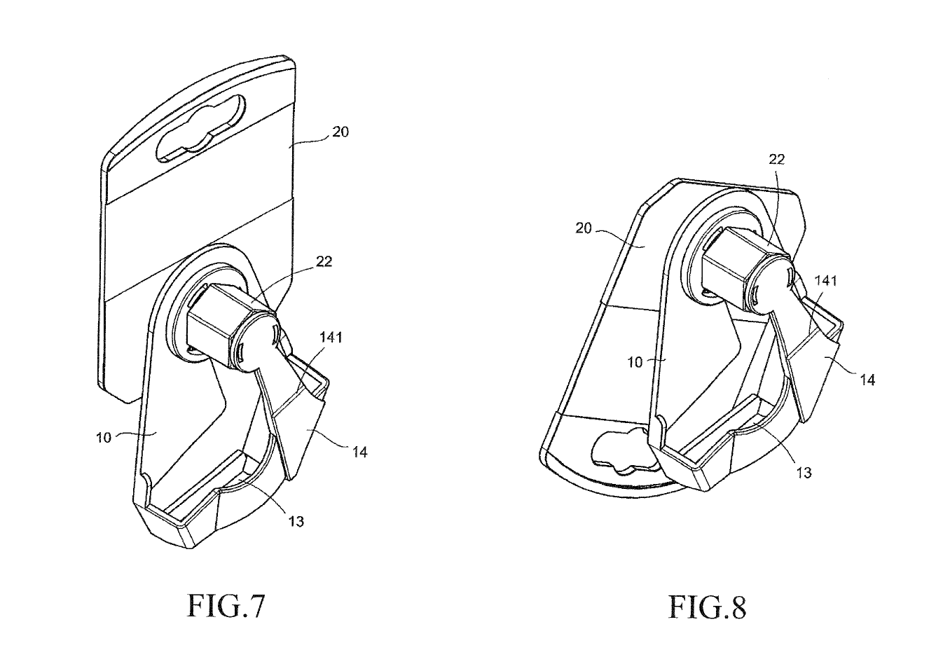

An alternative design is shown in FIGS. 6-8, wherein a central insertion and retention bar 11 is provided for a rotation-controllable ratchet spanner tool 30. A suspension plate 20 is provided to serve as a main portion for hanging the hanger body 10 in shop exhibition or sale site. The body 10 has an upper portion that forms a hanging hole extending through a central portion thereof. The suspension plate 20 has a lower portion from which an internal toothed bore 21 or a raised face projects to a predetermined height of a circumferential surface thereof. The hanging hole of the body and the projecting bore of the suspension plate are fit to each other for forming a suspending assembly. A retention axle 22 is then fit into the toothed bore 21 for retaining and positioning, whereby the hanger body 10 is mounted in a freely suspended manner and is thus allowed to free rotation. Besides an insertion slot 13 formed on a lower portion for insertion and hanging of a spanner tool 30, the surface of the hanger body 10 forms an extending retention board 14 on the body 10 or a side wall of the enclosing frame of the slot 13. With an insertion fastener 15 that is fanned on an end of the retention board 14 properly inserted into an insertion hole 23 defined centrally in the axle 22 to effectively secure and position the tool 30, the purposes of secure insertion and anti-theft hanging exhibition of a tool can be achieved. Further, when the end of the axle 22 is fit to a conventional hollow resilient fastening member 24, to prevent resilient separation of the hanging insertion, a positioning pin 25 is inserted into a corresponding hole defined in the backside of the suspension plate 20 to prevent the resilient fastening member 24 from undesired deformation, which may lead to falling of a hung object due to release of engagement. In this way, when hung exhibition is made, free rotation is allowable and when storage is desired after the exhibition, the suspension plate 20 is rotated to a location overlapping the back side of the hanger body 10 to thereby achieve an advantage of secure anti-theft utilization for hanging with a reduced packing size. A user, after purchasing, may uses scissors to cut off the retention board 14 for easy removal of the tool 30 for subsequent use. The hanger device may then be used as a device for hanging and storing of the tool after the use of the tool. For easy cutting with scissors, the cutting can be made at a thinned portion formed on the board surface close to the extension end of the retention board 14, or an additional thinned flange (not shown) is provided on the board for easy shearing.

Through the use of the retention board 14 provided by the present invention to easily enclose and cover an inserted head portion of an inserted tool 30 and also with an retention board 14 extending from one side or two sides of the hanger body 10 or extending directly from an enclosing frame of the insertion slot 13, which is made according to the size of the inserted head portion of the inserted tool 30, to enclose the tool 30, secure enclosing of the tool 30 that is properly inserted is realized to prevent the tool from detaching from the insertion slot 13 thereby achieving the purposes of secure hanging exhibition. With the ant-theft retention arrangement provided by the insertion fastener 15 formed on the retention board 14, a secure effect for enclosed hanging exhibition of a hung object can be realized. This, in combination with the easy suspending arrangement provided by the suspension plate 20, an effect of security and hanging exhibition is realized for an elongate spanner like tool 30. The structure of hanging and suspending is totally an easy molding and shows multiple practical advantages. The present invention is novel design in view of the conventional secure hanging devices of this category and also shows an efficacy of secure hanging that is superior to the conventional secure hanging devices of this type.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A secure tool hanger structure comprising a board like hanger body, an insertion slot defined by a projecting frame for receiving the insertion of a tool, and a positioning bar projecting from a central portion of the board surface, characterized in that the insertion slot is formed by enclosing frame members projecting from a lower portion of the hanger body for receiving the insertion of a spanner like elongate tool with a head portion of the tool being positioned against the bar projecting from the central portion of the board surface of the body, a retention board extending from a side of the body for enclosing the head portion of the tool with an insertion fastener extending from an extension end of the retention board directly fit into a central through hole defined in the bar to fixing and enclosing so as to realize secure enclosing exhibition that prevents the tool from falling off the hanger structure.

2. The secure tool hanger structure according to claim 1, wherein the retention board comprises a connected structure mounted to one side or two sides of the body.

3. The secure tool hanger structure according to claim 1, wherein the retention board 14 comprises a connected structure mounted to a side wall of the enclosing frame of the insertion slot.

4. The secure tool hanger structure according to claim 1, wherein the central through hole of the bar that is provided for the insertion of the insertion fastener of the extension end of the retention board is of a stepped configuration.

5. The secure tool hanger structure according to claim 1, wherein the central through hole of the bar projecting from a central portion of the hanger board forms a circumferentially recessed engagement groove for positioning purposes.

6. The secure tool hanger structure according to claim 1, wherein the retention board comprises a flexible board forming a looping band.

7. The secure tool hanger structure according to claim 1, wherein the retention board is connectedly mounted to the body and shows an L-shape projection, the retention board comprising an extending board surface forming, in an intermediate section thereof, a thinned fold line that allows the extension end to be bent outward.

8. The secure tool hanger structure according to claim 1, wherein the insertion fastener has an end forming a barb like end rim.

9. The secure tool hanger structure according to claim 1, wherein the hanger body has an upper portion forming in a central portion thereof a hanging hole for coupling with a suspension plate to achieve rotation controllable hanging.

10. The secure tool hanger structure according to claim 9, wherein the suspension plate forms a raised ring-shaped internal toothed bore for suspending the hanger body.

11. The secure tool hanger structure according to claim 10, wherein the internal toothed bore comprises a hollow resilient fastening member formed at a central portion thereof for being insertable, together with an axle, into and thus retaining the hanger body for assembly, which allows the body to be rotated.

12. The secure tool hanger structure according to claim 10, wherein the resilient fastening member forming a central hole into which a positioning pin is inserted.
